(19) United States
(12) Patent Application Publication
(10) Pub. No.: US 2009/0168303 A1
(43) Pub. Date: Jul. 2, 2009

(54) CAPACITOR DEVICE WITH THIN INTERPOSER

(75) Inventors: Katsuhiro YOSHIDA, Sendai-shi (JP); Tetsuya YOSHINARI, Sendai-shi (JP); Takeshi SAITO, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 12/343,600

(22) Filed: Dec. 24, 2008

(30) Foreign Application Priority Data
Dec. 28, 2007 (JP) 2007-339229

(51) Int. Cl. H01G 9/00

(52) U.S. Cl. 361/523

(57) ABSTRACT

A capacitor device comprises a capacitor element and an interposer. The capacitor element has a connection surface and comprises an anode electrode and a cathode electrode. The anode electrode and the cathode electrode are formed, at least in part, on the connection surface. The interposer comprises an insulator substrate, a plurality of first anode terminals, a plurality of first cathode terminals, a second anode terminal, a second cathode terminal, an anode through-hole and a cathode through-hole. The insulator substrate has first and second surfaces and has no inner conductive layer. The first anode terminals and the first cathode terminals are formed on the first surface. The first anode terminals are more in number than the anode electrode of the capacitor element. The first cathode terminals are more in number than the cathode electrode of the capacitor element The second anode terminal and the second cathode terminal are formed on the second surface. The second anode terminal is connected to the anode electrode. The second cathode terminal is connected to the cathode electrode. The anode through-hole and the cathode through-hole are formed in the insulator substrate. The anode through-hole connects between the first anode terminals and the second anode terminal. The cathode through-hole connects between the first cathode terminals and the second cathode terminal.

### CROSS REFERENCE TO RELATED APPLICATIONS

Applicants claim priority under 35 U.S.C. §119 of Japanese Application No. JP2007-339229 filed Dec. 28, 2007.

### BACKGROUND OF THE INVENTION

This invention relates to a capacitor device which has multiple terminals and is used in, for example, a power supply circuit.

As an operation frequency of an electronic instrument becomes higher, a capacitor device used therein is required to have lower equivalent serial inductance (ESL). One technique to reduce an ESL value of a capacitor device is to provide the capacitor device with a plurality of positive electrodes and a plurality of negative electrodes, wherein the positive electrodes and the negative electrodes are arranged alternately. Such a capacitor device with the reduced ESL is disclosed in JP-A 2002-343686 or JP-A 2005-108872, the contents of those documents being incorporated herein by reference in their entireties.

However, the capacitor device of JP-A 2002-343686 has a complex structure which lowers its yields. The capacitor device of JP-A 2005-108872 needs many small capacitor elements. However, many small capacitor elements decrease a capacitance per volume of the capacitor device and increase difficulty of fabrication of the capacitor device. In addition, it is difficult to manufacture both of the disclosed capacitor devices by using already known capacitor elements.

### SUMMARY OF THE INVENTION

It is an object of the present invention to provide a low ESL capacitor device which has a simple structure.

One aspect of the present invention provides a capacitor device which comprises a capacitor element and an interposer. The capacitor element has a connection surface and comprises an anode electrode and a cathode electrode. The anode electrode and the cathode electrode are formed, at least in part, on the connection surface. The interposer comprises an insulator substrate, a plurality of first anode terminals, a plurality of first cathode terminals, a second anode terminal, a second cathode terminal, an anode through-hole and a cathode through-hole. The insulator substrate has first and second surfaces and has no inner conductive layer. The first anode terminals and the first cathode terminals are formed on the first surface. The first anode terminals are more in number than the anode electrode of the capacitor element. The first cathode terminals are more in number than the cathode electrode of the capacitor element. The second anode terminal and the second cathode terminal are formed on the second surface. The second anode terminal is connected to the anode electrode. The second cathode terminal is connected to the cathode electrode. The anode through-hole and the cathode through-hole are formed in the insulator substrate. The anode through-hole connects between the first anode terminals and the second anode terminal. The cathode through-hole connects between the first cathode terminals and the second cathode terminal.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is an exploded, perspective view showing a capacitor device according to an embodiment of the present invention, wherein the capacitor device comprises a capacitor element and an interposer.

FIG. 2 is a cross-sectional view showing the capacitor element of FIG. 1, taken along lines I-II.

FIG. 3 is a cross-sectional view showing the interposer of FIG. 1, taken along lines III-III.

FIG. 4 is a top plan view showing an initial manufacturing process of the interposer of FIG. 1.

FIG. 5 is a cross-sectional view showing the manufacturing process of FIG. 4, taken along lines V-V.

FIG. 6 is a top plan view showing a subsequent manufacturing process of the interposer of FIG. 1.

FIG. 7 is a cross-sectional view showing the manufacturing process of FIG. 6, taken along lines VII-VII.

FIG. 8 is a top plan view showing a subsequent manufacturing process of the interposer of FIG. 1

FIG. 9 is a cross-sectional view showing the manufacturing process of FIG. 8, taken along lines IX-IX.

FIG. 10 is a bottom plan view showing the manufacturing process of FIG. 8.

FIG. 11 is a top plan view showing a subsequent manufacturing process of the interposer of FIG. 1.

FIG. 12 is a cross-sectional view showing the manufacturing process of FIG. 11, taken along lines XII-XII.

FIG. 13 is an exploded, perspective view showing a modification of the capacitor device of FIG. 1.

FIG. 14 is a cross-sectional view showing the capacitor element of FIG. 13, taken along lines XIV-XIV.

FIG. 15 is a cross-sectional view showing the interposer of FIG. 13, taken along lines XV-XV.

While the invention is susceptible to various modifications and alternative forms; specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications equivalents and alternatives falling within the spirit and scope of the present invention as defined by the appended claims.

### DESCRIPTION OF PREFERRED EMBODIMENTS

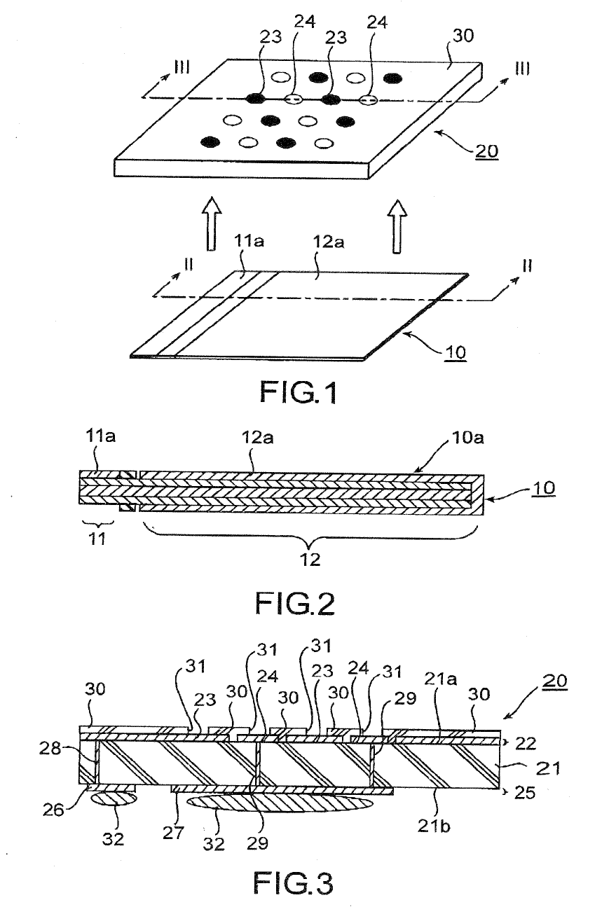

With reference to FIGS. 1 to 3, a capacitor device according to an embodiment of the present invention comprises a capacitor element 10 and an interposer 20

The capacitor element 10 of the present embodiment is an aluminum solid electrolyte capacitor. In this embodiment, the capacitor element 10 has an area size of 7.3 mm×4.3 mm, a capacitance of 40 μF, an equivalent serial resistance (ESR) of 8 mΩ, and an ESL of about 1000 pH.

As shown in FIG. 2, the capacitor element 10 has a connection surface 10a. The capacitor element 10 comprises an anode section 11 and a cathode section 12. The anode section 11 comprises an anode electrode 11a which is formed on the connection surface 10a. The anode electrode 11a of the present embodiment is made of copper. The cathode section 12 comprises a cathode electrode 12a, a part of which is formed on the connection surface 10a. The cathode electrode 12a of the present embodiment is made of silver. In this embodiment, the number of the anode electrode 11a is one. Likewise, the number of the cathode electrode 12a is one.

The interposer 20 of the present embodiment has an area size same as that of the capacitor element 10, i.e. 7.3 mm×4.3 mm. In addition, the interposer 20 of the present embodiment has a thickness of 74 μm As shown in FIG. 3, the interposer 20 is formed of a double-sided conductor board that comprises an insulator substrate 21, a first patterned conductive layer 22, a second patterned conductive layer 25 and a solder resist layer 30. The interposer 20 of the double-sided conductor board comprises no conductive layer except for the aforementioned first patterned conductive layer 22 and the aforementioned second patterned conductive layer 25. In other words, the interposer 20 of the double-sided conductor board comprises no inner conductive layer.

The insulator substrate 21 has a first surface 21a and a second surface 21b. The first patterned conductive layer 22 is formed on the first surface 21a of the insulator substrate 21, while the second patterned conductive layer 25 is formed on the second surface 21b of the insulator substrate 21; the second surface 21b is a back surface of the first surface 21a. The solder resist layer 30 is formed on the first patterned conductive layer 22. the solder resist layer 30 is formed with a plurality of apertures 31, which are arranged in a matrix form.

The first patterned conductive layer 22 comprises a plurality of first anode terminals 23 and a plurality of first cathode terminals 24. In other words, the first anode terminals 23 and the first cathode terminals 24 are formed on the first surface 10a. In this embodiment, each of the first cathode terminals 24 is a small island which is electrically isolated from the other first cathode terminals 24 and the rest of the first patterned conductive layer 22. Each of the first anode terminals 23 is a part of the rest of the first patterned conductive layer 22. In other words, the first anode terminals 23 are mutually connected in the first patterned conductive layer 22. The first anode terminals 23 and the first cathode terminals 24 are reachable from an outside of the interposer 20 through the respective apertures 31 of the solder resist layer 30. The first anode terminals 23 and the first cathode terminals 24 are arranged alternately in both of rows and columns, as shown in FIG. 1.

As shown in FIG. 3, the second patterned conductive layer 25 comprises a second anode terminal 26 and a second cathode terminal 27. In other words, the second anode terminal 26 and the second cathode terminal 27 are formed on the second surface 10b. In this embodiment, the number of the second anode terminal 26 is one. Likewise, the number of the second cathode terminal 27 is also one

The insulator substrate 21 is further formed with anode through-holes 28 and cathode through-holes 29. The anode through-holes 28 electrically connect the first anode terminals 23 and the second anode terminal 26. In other words, all of the anode through-holes 28 are connected to the single second anode terminal 26 and to the rest of the first patterned conductive layer 22, especially to the peripheral region of the first patterned conductive layer 22. The cathode through-holes 29 connect the respective first anode terminals 24 to the second anode terminal 27. In other words, all of the cathode through-holes 29 are connected to the single second cathode terminal 27, while the cathode through-holes 29 are directly connected to the respective first anode terminals 24. In this embodiment, the anode through-holes 28 are connected to the first anode terminals 23 through the rest of the first patterned conductive layer 22, as mentioned above. In other words, the anode through-holes 28 is formed within a predetermined region on the first surface 21a of the insulator substrate 21, wherein the predetermined region includes neither the anode through-holes 28 nor the cathode through-hole 29.

As apparent from FIGS. 1 to 3, the first anode terminals 23 are more in number than the anode electrode 11a of the capacitor element 10, and the first cathode terminals 24 are more in number than the cathode electrode 12a of the capacitor element 10.

As apparent from FIGS. 1 to 3, the contact surface 10a of the capacitor element 10 is mounted on the interposer 20 so that the capacitor device of the present embodiment is obtained. In detail, the second anode terminal 26 is connected to the anode electrode 11a by means of a conductive adhesive 32. Likewise, the second cathode terminal 27 is connected to the cathode electrode 12a by means of a conductive adhesive 32. The thus-obtained capacitor device is thin because the interposer 20 has no inner conductive layer. In addition, the capacitor device has multiple terminals causing low ESL while the already-known capacitor element can also be used because of the interposer 20.

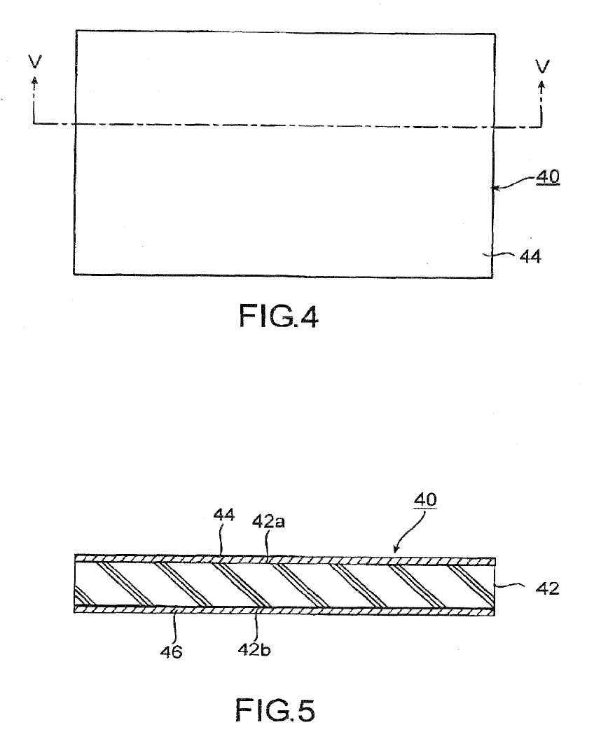

Next explanation is made about the manufacturing method of the capacitor device, especially, the interposer 20, with reference to FIGS. 4 to 8.

First, a double-sided conductor board 40 is prepared as a base material, with reference to FIGS. 4 and 5. The double-sided conductor board 40 comprises an insulator substrate 42, a first conductive layer 44 and a second conductive layer 46. The insulator substrate 42 is made of glass epoxy and has a thickness of 40 μm. The insulator substrate 42 has two surfaces 42a, 42b, on which the first conductive layer 44 and the second conductive layer 46 are formed, respectively. The first conductive layer 44 and the second conductive layer 46 are made of copper. Each of the first conductive layer 44 and the second conductive layer 46 has a thickness of 8 μm.

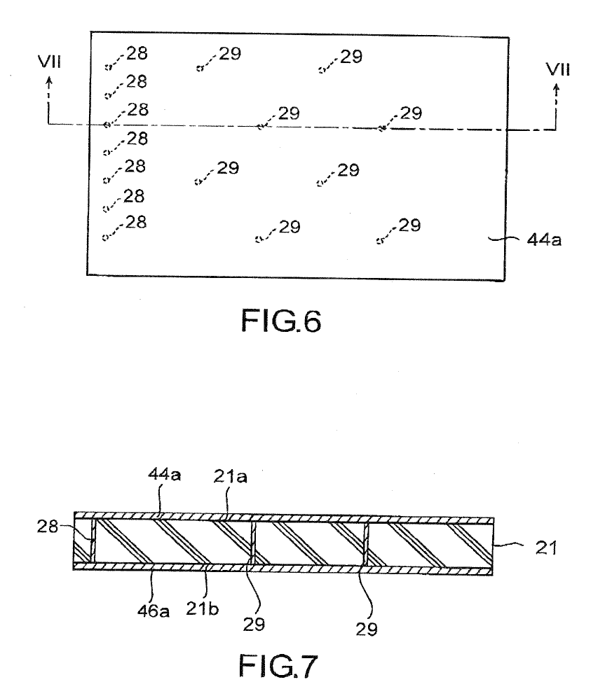

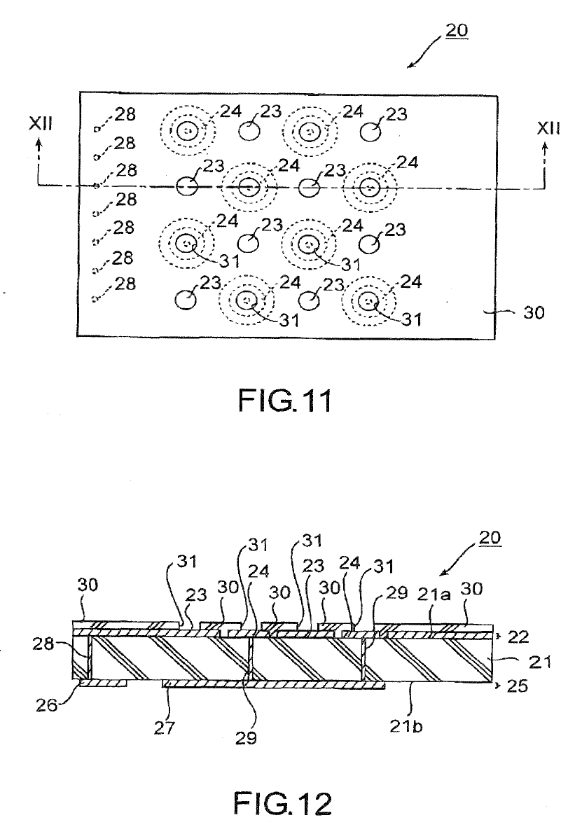

Next, the anode through-holes 28 and the cathode through-holes 29 are formed in the insulator substrate 21, as shown in FIGS. 6 and 7. In detail, a plurality of holes are formed in the insulator substrate 42, each of the holes piercing the insulator substrate 42 and having a diameter of 100 μm. Inner walls of the holes are plated with copper through an electroless plating method and an electro-plating method. The thus-obtained copper-plating has a thickness of 4 μm and serves as the anode through-hole 28 or the cathode through-hole 29. In the plating process, the first conductor layer 44 of 8 μm thickness is converted into a first conductor layer 44a of 12 μm thickness. Likewise, the second conductor layer 46 of 8 μm thickness is converted into a second conductive layer 46a of 12 μm. The anode through-holes 28 are arranged in a line, as shown in FIG. 6. Each of the anode through-holes 2a is separated from a side edge of the first conductive layer 44a by 0.5 mm. The number of the anode through-holes 28 is seven. The pitch between the anode through-holes 28 is 0.5 mm. The cathode through-holes 29 are arranged to correspond to the first cathode terminals 24, respectively, as understood from FIGS. 6 and 11 The number of cathode terminals 24 is eight.

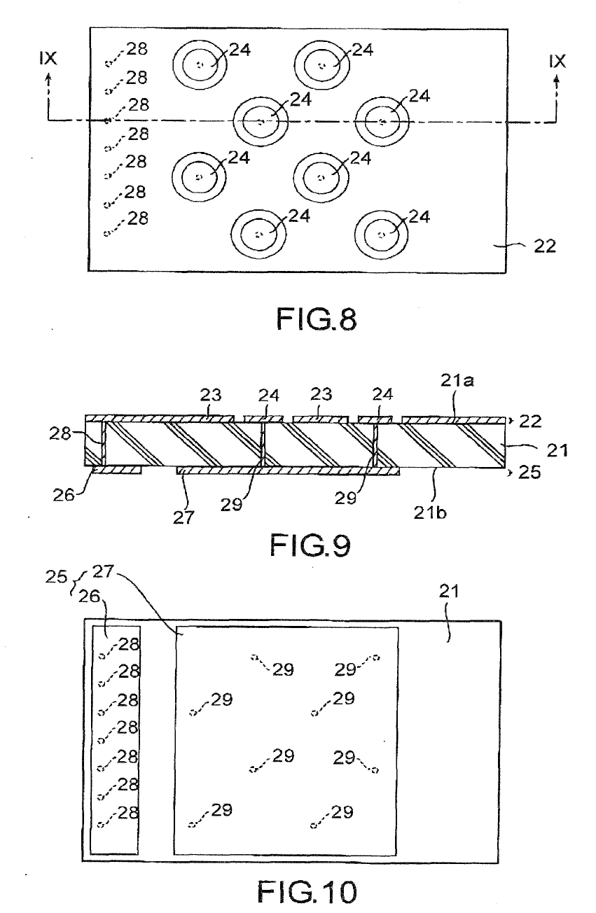

Next, the first and the second conductive layers 44a, 46a are patterned through an etching process. In detail, the first conductive layer 44 is etched so that the first patterned conductive layer 22 comprises small islands which serve as the first cathode terminals 24, respectively, as shown in FIGS. 8 and 9. Likewise, the second conductive layer 46 is etched so that the second patterned conductive layer 25 comprises the second anode terminal 26 and the second cathode terminal 27, as shown in FIGS. 9 and 10. As apparent from FIG. 10, the anode through-holes 28 are covered by the second anode terminal 26 of strip shape, and the cathode through-holes 29 are covered by the second cathode terminal 27 of rectangle shape.

Next, the solder resist layer 30 is provided on the first patterned conductive layer 22 so that the interposer 20 is obtained, as shown in FIGS. 11 and 12. In detail, the solder resist layer 30 is formed with a plurality of the apertures 31, eight of which correspond to the first anode terminals 23, respectively, while the other eight apertures 31 correspond to the first cathode terminals 24, respectively, as explained above. As apparent from FIGS. 8, 10 and 11, all of the first anode terminals 23 and the first cathode terminals 24 are formed within a region corresponding to the second cathode terminal 27 and are separated from the anode through-holes 28.

In this embodiment, the first anode terminals 23, the first cathode terminals 24, the second anode terminal 26 and the second cathode terminal 27 are covered with a nickel layer and a gold layer by electroless plating processes. The total thickness of the nickel layer and the gold layer is about 0.2 μm. The thus-obtained interposer 20 has an average thickness of 74 μm.

The interposer 20 is fixed to the capacitor element 10 by the conductive adhesives 32. The conductive adhesive 32 includes silver fillers. The capacitor element 10 fixed to the interposer 20 is covered by a resin (not shown) so that the capacitor device of the present embodiment is obtained. The obtained capacitor device has an ESL of 200 pH at 200 MHz. Because of the interposer 20, the obtained capacitor device has one fifth ESL in comparison with the capacitor element 10. The low ESL capacitor device has an average thickness of 0.4 mm.

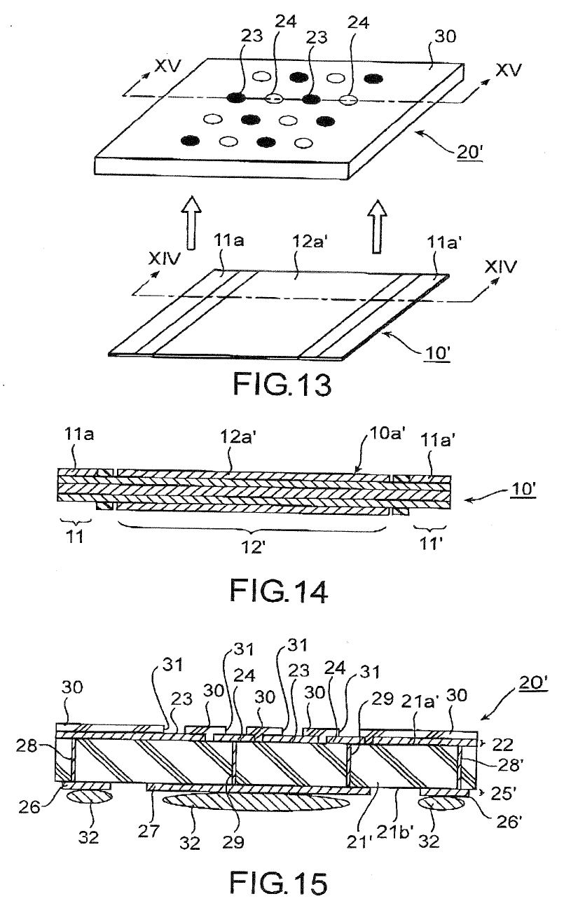

The above-mentioned embodiment can be modified, for example, as illustrated in FIGS. 13 to 15. Like numerals are used to denote like elements in FIGS. 1 to 3 and FIGS. 13 to 15. In this modification, the capacitor element 10′ has two anode sections 11 and 11′, which have anode electrodes 11 and 11a′, separately. The anode electrodes 11a, 11a′ are positioned at the opposite ends of the capacitor element 10′ so that a cathode electrode 12a′ of a cathode section 12′ is positioned between the anode electrodes 11a, 11a′. The capacitor element 10′ has a capacitance of 33 μF and an ESR of 13 mΩ.

The interposer 20′ further comprises a set of anode through-holes 28′, which is arranged in a line. Each of the anode through-holes 28′ is separated by 5 mm from the other side edge of the first patterned conductive layer 22.

The capacitor device of the modification has an average thickness of 0.4 mm, which is same as the embodiment mentioned above. ESL of the capacitor device of the modification is 100 pH and is lowered in comparison with the above-mentioned embodiment.

Although the insulator substrate 21 is made of glass epoxy in the above-mentioned embodiment, the present invention is not limited thereto For example, the insulator substrate 21 may be made of a polyimide film. For example, if the polyimide film has a thickness of 25 μm, an average thickness of the interposer 20 becomes 60 μm, which is thinner than the abovementioned embodiment by 15 μm.

The present application is based on a Japanese patent application of JP2007-339229 filed before the Japan Patent Office on Dec. 28, 2007, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A capacitor device comprising:
a capacitor element having a connection surface, the capacitor element comprising an anode electrode and a cathode electrode, the anode electrode and the cathode electrode being formed, at least in part, on the connection surface; and
an interposer comprising an insulator substrate, a plurality of first anode terminals, a plurality of first cathode terminals, a second anode terminal, a second cathode terminal, an anode through-hole and a cathode through-hole, the insulator substrate having first and second surfaces and having no inner conductive layer, the first anode terminals and the first cathode terminals being formed on the first surface, the first anode terminals being more in number than the anode electrode of the capacitor element, the first cathode terminals being more in number than the cathode electrode of the capacitor element, the second anode terminal and the second cathode terminal being formed on the second surface, the second anode terminal being connected to the anode electrode, the second cathode terminal being connected to the cathode electrode, the anode through-hole and the cathode through-hole being formed in the insulator substrate, the anode through-hole connecting between the first anode terminals and the second anode terminal, the cathode through-hole connecting between the first cathode terminals and the second cathode terminal.

2. The capacitor device according to claim 1, wherein the interposer comprises a double-sided conductor board which comprises the insulator substrate, a first patterned conductive layer and a second patterned conductive layer, the first patterned conductive layer comprising the first anode terminals and the first cathode terminals, the second patterned conductive layer comprising the second anode terminal and the second cathode terminal.

3. The capacitor device according to claim 2, wherein at least one of the first anode terminals and the first cathode terminals is formed within a predetermined region on the first surface of the insulator substrate, the predetermined region including neither the anode through-hole nor the cathode through-hole.

4. The capacitor device according to claim 2, wherein the interposer further comprises a solder resist layer formed on the first patterned conductive layer, the solder resist layer being formed with a plurality of apertures, the first anode terminals and the first cathode terminals being reachable from an outside of the interposer through the apertures.

5. The capacitor device according to claim 1, wherein the first anode terminals and the first cathode terminals are formed as a specific matrix of terminals in which first anode terminals and the first cathode terminals are alternately arranged.

6. The capacitor device according to claim 1, wherein the capacitor element is a solid electrolyte capacitor.

7. The interposer recited in claim 1.
